(19) United States
(12) Patent Application Publication
(10) Pub. No.: US 2018/0018237 A1
(43) Pub. Date: Jan. 18, 2018

(54) INFORMATION PROCESSING APPARATUS AND INFORMATION PROCESSING SYSTEM

(71) Applicant: FUJITSU LIMITED, Kawasaki-shi (JP)

(72) Inventor: Yuji MORITA, Shinagawa (JP)

(73) Assignee: FUJITSU LIMITED, Kawasaki-shi (JP)

(21) Appl. No.: 15/631,671

(22) Filed: Jun. 23, 2017

(30) Foreign Application Priority Data
Jul. 14, 2016 (JP) 2016-139099

(51) Int. Cl. G06F 11/14; G06F 11/20

(52) U.S. Cl. CPC G06F 11/1461; G06F 11/1469; G06F 11/2074

(57) ABSTRACT

An information processing apparatus includes a storage unit and a control unit. The storage unit stores therein data transfer rate information about a data transfer rate to a first storage apparatus and a data transfer rate to a second storage apparatus, and save data to be saved when a disaster occurs. The control unit obtains disaster prediction information about a disaster prediction, creates a saving plan for saving the save data by copying to the first storage apparatus and copying to the second storage apparatus, on the basis of a predicted disaster time detected from the disaster prediction information and the data transfer rate information, and then saves the save data in the first storage apparatus and the second storage apparatus in accordance with the saving plan.

### CROSS-REFERENCE TO RELATED APPLICATION

This application is based upon and claims the benefit of priority of the prior Japanese Patent Application No. 2016-139099, filed on Jul. 14, 2016, the entire contents of which are incorporated herein by reference.

### FIELD

The embodiments discussed herein relate to an information processing apparatus and an information processing system.

### BACKGROUND

Asynchronous remote copy is known as a data backup technique. In the asynchronous remote copy, an information processing apparatus holds data received from a higher-level apparatus, and notifies the higher-level apparatus that the remote copy is complete, without waiting for the remote copy to complete. After the completion notification of the remote copy, the information processing apparatus transfers the data and completes the remote copy.

Such asynchronous remote copy has the risk of losing data before transmission to a remote copy destination if the information processing apparatus is damaged by a disaster or the like before the data transmission to the remote copy destination is complete.

To deal with this, there has been proposed a technique for preventing the loss of the data before transmission to the remote copy destination even if the information processing apparatus is damaged by a disaster or the like. For example, a mirroring application running on a remote copy source holds data to be copied, in a disaster-proof storage unit while awaiting a response indicating completion of an asynchronous remote copy from a primary storage device to a secondary storage device.

Please see, for example, Japanese National Publication of International Patent Application No. 2008-538624.

However, in general, disaster-proof storage units are expensive. Therefore, it would increase the cost of a system to prepare such a storage unit for saving all data to be saved. Although data to be saved may be reduced on Wide Area Network (WAN) links or other high-speed network links, use of such links also increases the cost of the system.

### SUMMARY

According to one aspect, there is provided an information processing apparatus that includes: a memory configured to store therein data transfer rate information about a data transfer rate to a first storage apparatus located at a remote site and a data transfer rate to a second storage apparatus that is disaster-proof, and save data to be saved when a disaster occurs; and a processor configured to perform a process including obtaining disaster prediction information about a disaster prediction, creating a saving plan for saving the save data by copying to the first storage apparatus and copying to the second storage apparatus, based on a predicted disaster time detected from the disaster prediction information and the data transfer rate information, and saving the save data in the first storage apparatus and the second storage apparatus in accordance with the saving plan.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processing system according to a first embodiment;

FIG. 2 illustrates an example of an information processing system according to a second embodiment;

FIG. 3 illustrates an example of hardware of a controller module according to the second embodiment;

FIG. 4 illustrates an example of functions of a controller module used as a remote copy source according to the second embodiment;

FIG. 5 illustrates an example of functions of a controller module used as a remote copy destination according to the second embodiment;

FIG. 6 illustrates a disaster information list according to the second embodiment;

FIG. 7 illustrates an example of a saving plan according to the second embodiment;

FIG. 8 illustrates a save data list according to the second embodiment;

FIGS. 9 and 10 illustrate an example of a flowchart for a data saving process according to the second embodiment;

FIGS. 11 and 12 illustrate an example of a flowchart for a saving plan creation process according to the second embodiment;

FIG. 13 illustrates an example of a flowchart for a sorting process according to the second embodiment;

FIG. 14 illustrates an example of a flowchart for a merging process according to the second embodiment;

FIG. 15 illustrates an example of a flowchart for a storing process according to the second embodiment; and

FIGS. 16 and 17 illustrate an example of a flowchart for a recovery process according to the second embodiment.

### DESCRIPTION OF EMBODIMENTS

Several embodiments will be described below with reference to the accompanying drawings, wherein like reference numerals refer to like elements throughout.

### First Embodiment

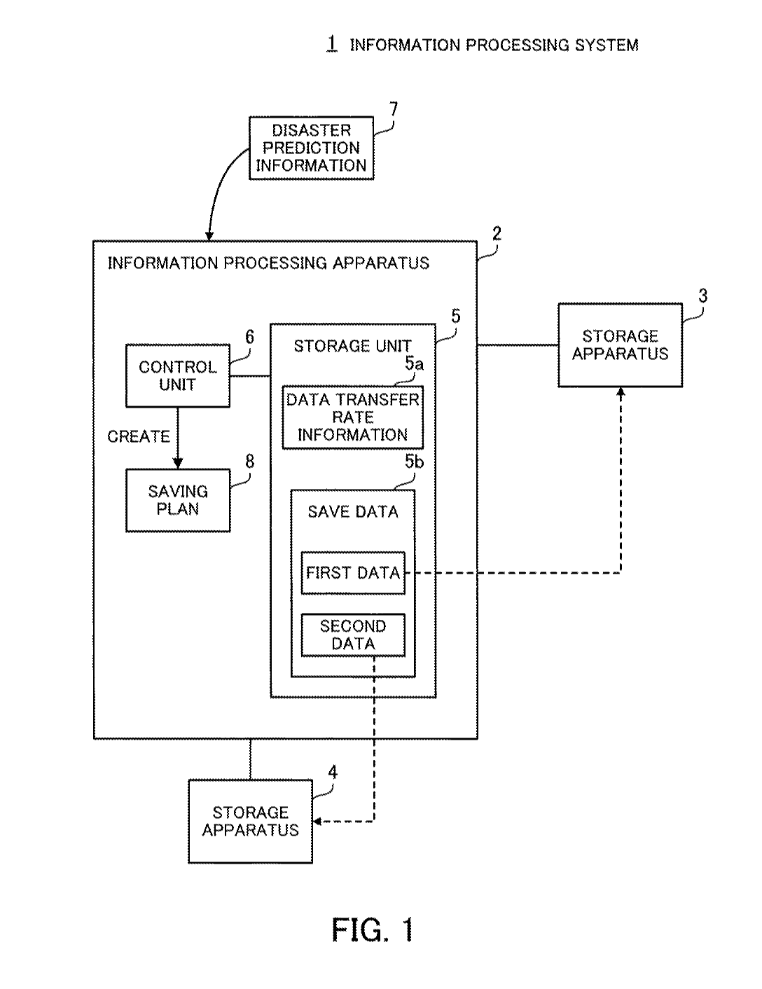

FIG. 1 illustrates an example of an information processing system according to a first embodiment. The information processing system 1 includes an information processing apparatus 2 and storage apparatuses 3 and 4. The information processing apparatus 2 and storage apparatus 3 are connected over a network. The information processing apparatus 2 is able to copy data to the storage apparatus 3 that is located at a remote site. For example, the information processing apparatus 2 is able to asynchronously copy data to the storage apparatus 3 (that is, asynchronous copy, for example, remote copy). In addition, the information processing apparatus 2 is able to copy data to the storage apparatus 4 that is disaster-proof. For example, the information processing apparatus 2 is able to synchronously copy data to the storage apparatus 4 (that is, synchronous copy).

The information processing apparatus 2 includes a storage unit 5 and a control unit 6. The storage unit 5 stores therein data transfer rate information 5a and save data 5b. For example, the storage unit 5 is a Random Access Memory (RAM) or the like. The data transfer rate information 5a is information about a data transfer rate to the storage apparatus 3 and a data transfer rate to the storage apparatus 4. The save data 5b is data to be saved when a disaster occurs. For example, the save data 5b is copied when an asynchronous remote copy to the storage apparatus 3 is performed.

The control unit 6 obtains disaster prediction information 7 about a disaster prediction. For example, the control unit 6 is implemented by causing a processor to execute an intended process. For example, the control unit 6 obtains the disaster prediction information 7 from an external apparatus (not illustrated) or receives the disaster prediction information 7 entered by a user. The disaster prediction information 7 is information about a disaster prediction for the information processing apparatus 2, and includes information specifying a predicted disaster time. The predicted disaster time indicates when the information processing apparatus 2 is predicted to suffer from a disaster.

The control unit 6 detects the predicted disaster time from the disaster prediction information 7. Then, the control unit 6 creates a saving plan 8 on the basis of the predicted disaster time and the data transfer rate information 5a. The saving plan 8 is created for saving the save data 5b by copying to the storage apparatus 3 and by copying to the storage apparatus 4.

For example, the control unit 6 plans to save first data among the save data 5b in the storage apparatus 3. Among the save data 5b, the first data is copyable to the storage apparatus 3 by the predicted disaster time at the data transfer rate to the storage apparatus 3, which is indicated by the data transfer rate information 5a. In addition, the control unit 6 plans to save second data among the save data 5b in the storage apparatus 4. Among the save data 5b, the second data is copyable to the storage apparatus 4 by the predicted disaster time at the data transfer rate to the storage apparatus 4, which is indicated by the data transfer rate information 5a. In one aspect, among the save data 5b, the second data is data that is not copyable to the storage apparatus 3 by the predicted disaster time at the data transfer rate to the storage apparatus 3, which is indicated by the data transfer rate information 5a. In this way, the control unit 6 creates the saving plan 8 for saving the first data in the storage apparatus 3 and the second data in the storage apparatus 4.

The control unit 6 saves the save data 5b in the storage apparatuses 3 and 4 in accordance with the saving plan 8. For example, the control unit 6 saves the first data in the storage apparatus 3 and the second data in the storage apparatus 4 in accordance with the saving plan 8.

According to the first embodiment, the control unit 6 saves the first data in the storage apparatus 3 and the second data in the storage apparatus 4. This technique enables the information processing apparatus 2 to reduce the risk of losing the save data 5b.

Further, according to the first embodiment, the control unit 6 saves the save data 5b in the storage apparatuses 3 and 4 in a distributed manner. In this technique, the information processing apparatus 2 does not need to save all the save data 5b in the storage apparatus 3. Therefore, in the information processing system 1, it is possible to reduce the cost for bandwidth reservation for a communication link between the information processing apparatus 2 and the storage apparatus 3.

In addition, the information processing apparatus 2 saves the save data 5b in the storage apparatuses 3 and 4 in a distributed manner, which makes it possible to reduce a memory capacity needed for the storage apparatus 4. Since the information processing system 1 does not need a disaster-proof storage unit for storing all the save data 5b, it is possible to reduce the cost for the disaster-proof storage unit.

Thus, the information processing system 1 and information processing apparatus 2 are able to reduce the risk of losing data at a low cost.

### Second Embodiment

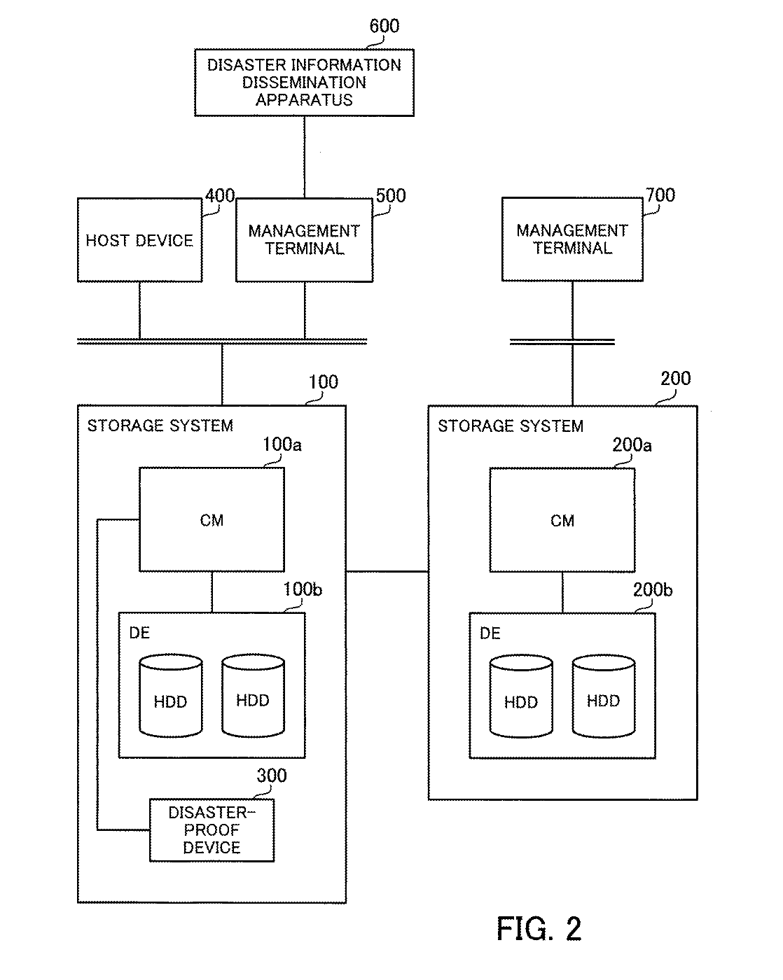

FIG. 2 illustrates an example of an information processing system according to a second embodiment. The information processing system includes storage systems 100 and 200 and a disaster-proof device 300. The storage system 100 stores therein data that is used by a host device 400. The storage system 100 includes a Controller Module (CM) 100a and Device Enclosure (DE) 100b. The controller module 100a controls access from the host device 400 to the device enclosure 100b. In this connection, the storage system 100 may include two or more controller modules. The device enclosure 100b is a disk array device that accommodates a plurality of storage devices. In this connection, the device enclosure 100b may accommodate Hard Disk Drives (HDDs), Solid State Drives (SSDs), and others as storage devices. In addition, the storage system 100 does not need to be installed in a data center. For example, the storage system 100 may be installed in a low-cost environment, such as a branch office or a local factory.

The disaster-proof device 300 is a storage device that is disaster-proof. The disaster-proof property of storage devices is to protect stored data from disasters. The casing of the disaster-proof device 300 is not damaged by disasters, and a plurality of storage devices are accommodated therein. In this connection, the disaster-proof device 300 may be provided integrally with or independently of the storage system 100.

The storage system 200 functions as a backup device for storing a backup of data stored in the storage system 100. The storage system 200 is installed at a remote site where there is no fear of suffering from disasters at the same time as the storage system 100. For example, the storage system 200 is installed 100 kilometers or more away from the storage system 100.

The storage system 200 includes a Controller Module (CM) 200a and a Device Enclosure (DE) 200b. The controller module 200a entirely controls the storage system 200. In this connection, the storage system 200 may include two or more controller modules. The device enclosure 200b is a disk array device that accommodates a plurality of storage devices. In this connection, in the device enclosure 200b, HDDs, SSDs, and others may be accommodated.

Management terminals 500 and 700 are used by administrators. A disaster information dissemination apparatus 600 disseminates disaster information. For example, the disaster information dissemination apparatus 600 is operated by the Meteorological Agency. In this connection, the disaster information is an example of the disaster prediction information 7 of the first embodiment. The management terminal 500 receives the disaster information from the disaster information dissemination apparatus 600.

The storage systems 100 and 200 are connected over a network. The storage system 100, host device 400, and management terminal 500 are connected over a network. For example, the storage system 100, host device 400, and management terminal 500 are connected with a network technology, such as a Fibre Channel (FC).

The management terminal 500 and disaster information dissemination apparatus 600 are connected over a network. For example, the management terminal 500 and disaster information dissemination apparatus 600 are connected via a wide-area network, such as the Internet. In addition, the storage system 200 and management terminal 700 are connected over a network. For example, the storage system 200 and management terminal 700 are connected with a network technology, such as a Fibre Channel (FC).

The storage system 100 performs an asynchronous remote copy of data received from the host device 400, to the storage system 200 that is a remote copy destination.

In this connection, the storage system 100 or the controller module 100a is an example of the information processing apparatus 2 of the first embodiment. The storage system 200 is an example of the storage apparatus 3 of the first embodiment. The disaster-proof device 300 is an example of the storage apparatus 4 of the first embodiment.

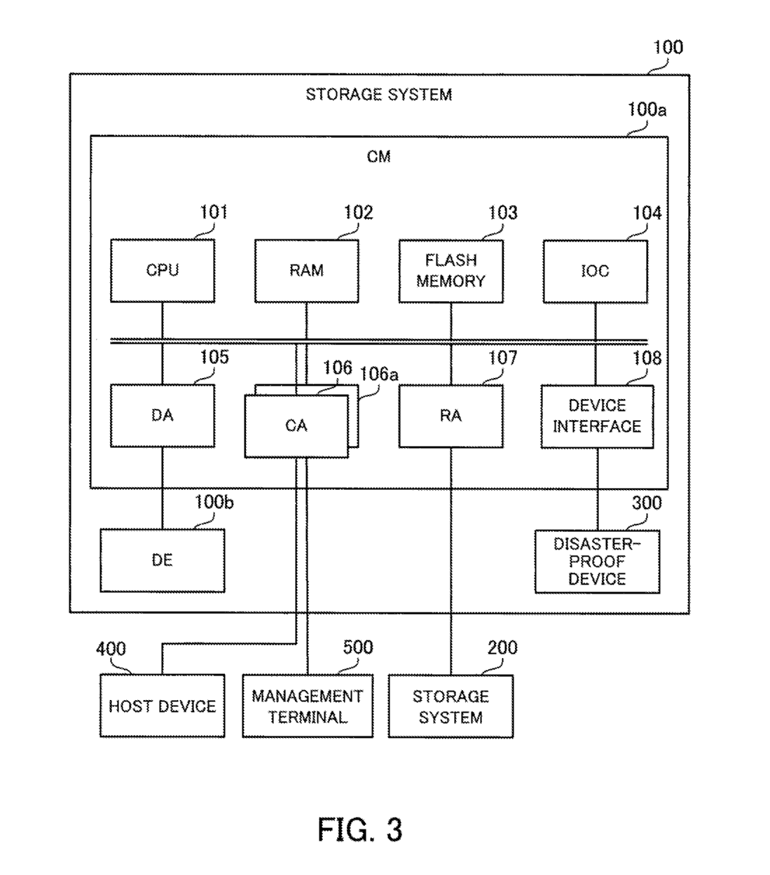

FIG. 3 illustrates an example of hardware of a controller module according to the second embodiment. The controller module 100a includes a Central Processing Unit (CPU) 101, a RAM 102, a flash memory 103, an Input-Output Controller (IOC) 104, a Disc Adapter (DA) 105, Channel Adapters (CA) 106 and 106a, a Remote Adapter (RA) 107, and a device interface 108.

The CPU 101 controls information processing performed by the controller module 100a. The CPU 101 may be a Digital Signal Processor (DSP), Application Specific Integrated Circuit (ASIC), Field Programmable Gate Array (FPGA), or another. In addition, the CPU 101 may be a multiprocessor.

The RAM 102 is a primary storage device of the controller module 100a. The RAM 102 temporarily stores at least part of Operating System (OS) programs and application programs to be executed by the CPU 101. In addition, the RAM 102 stores various data that is used by the CPU 101 in processing.

The flash memory 103 is an auxiliary storage device of the controller module 100a. The flash memory 103 is a non-volatile storage device. The flash memory 103 stores the OS programs, application programs, and various data. In this connection, the controller module 100a may include an HDD as an auxiliary storage device, instead of the flash memory 103.

The input-output controller 104 controls access from the host device 400 to the device enclosure 100b. The disk adapter 105 is an interface for communication with the device enclosure 100b. The channel adapter 106 is an interface for communication with the host device 400. The channel adapter 106a is an interface for communication with the management terminal 500. The remote adapter 107 is an interface for communication with the storage system 200. The device interface 108 is an interface for communication with the disaster-proof device 300. In this connection, the controller module 200a may be implemented by using the same hardware as the controller module 100a.

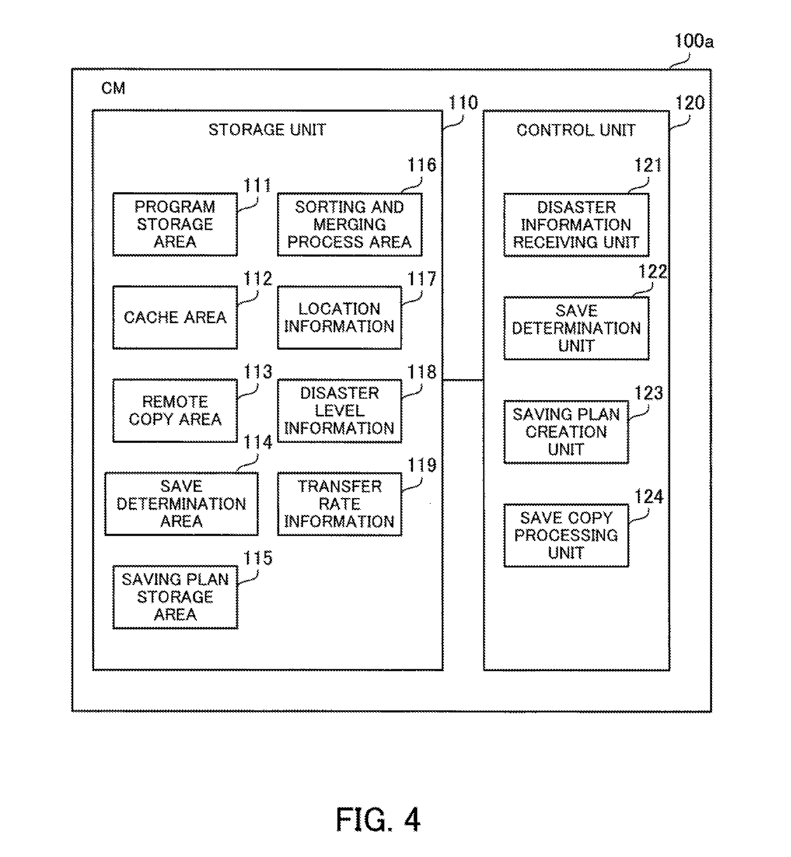

FIG. 4 illustrates an example of functions of a controller module used as a remote copy source according to the second embodiment. The controller module 100a includes a storage unit 110 and a control unit 120.

The storage unit 110 includes a program storage area 111, a cache area 112, a remote copy area 113, a save determination area 114, a saving plan storage area 115, a sorting and merging process area 116, location information 117, disaster level information 118, and transfer rate information 119. For example, the storage unit 110 is implemented as a storage space set aside in the RAM 102.

The program storage area 111 stores therein programs to be executed by the CPU 101. The cache area 112 stores therein data to be subjected to information processing by the CPU 101. The remote copy area 113 stores therein data to be copied to the storage system 200 in an asynchronous remote copy.

The save determination area 114 is used by a save determination unit 122. The saving plan storage area 115 stores therein a saving plan. The saving plan is an example of the saving plan 8 of the first embodiment. The sorting and merging process area 116 is used in a sorting process and a merging process, as will be described later.

The location information 117 indicates where the storage system 100 is installed. The disaster level information 118 indicates a threshold for a disaster level used as a criterion for determining impact of the disaster. The threshold for the disaster level is set for each type of disaster. The transfer rate information 119 includes information indicating an effective link rate for executing remote copy to the storage system 200. For example, the effective link rate is 80 Mbps. The transfer rate information 119 also includes information indicating an effective copy rate for copying data to the disaster-proof device 300. For example, the effective copy rate is 190 Mbps. In this connection, the transfer rate information 119 is an example of the data transfer rate information 5a of the first embodiment.

In addition to the above, the storage unit 110 may store therein priority information. The priority information indicates priority to be used in the sorting process, which will be described later.

The control unit 120 includes a disaster information receiving unit 121, the save determination unit 122, a saving plan creation unit 123, and a save copy processing unit 124. For example, at least part of processes performed by the control unit 120 may be implemented by causing the CPU 101 to execute intended programs.

The disaster information receiving unit 121 receives disaster information disseminated by the disaster information dissemination apparatus 600. The save determination unit 122 determines whether the storage system 100 will suffer from the disaster or not, on the basis of the disaster information. If it is determined that the storage system 100 will suffer from the disaster, the save determination unit 122 takes, as data to be saved, data that is stored in the remote copy area 113 and is to be remotely copied. Hereinafter, the data to be saved is referred to as save data.

The saving plan creation unit 123 creates a saving plan. The saving plan includes information indicating an amount of data to be remotely copied to the storage system 200 for saving by the storage system 100, an amount of data to be copied to the disaster-proof device 300 for saving by the storage system 100, and others. In addition, the saving plan creation unit 123 performs a sorting process and a merging process when creating the saving plan. The sorting process and merging process will be described in detail later.

The save copy processing unit 124 sends the saving plan to the storage system 200. In addition, the save copy processing unit 124 copies the save data to the storage system 200 and disaster-proof device 300 in accordance with the saving plan. This enables the controller module 100a to reduce the risk of losing the save data.

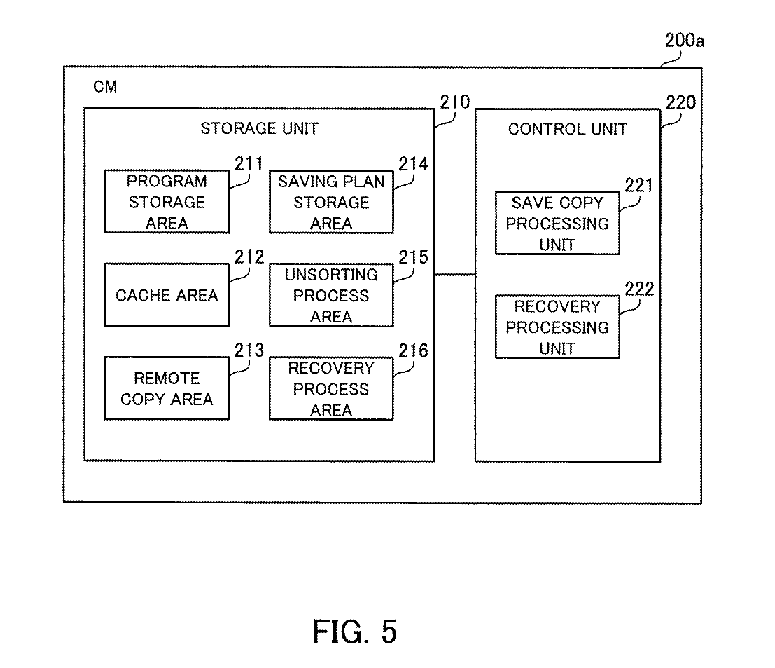

FIG. 5 illustrates an example of functions of a controller module used as a remote copy destination according to the second embodiment. The controller module 200a includes a storage unit 210 and a control unit 220. The storage unit 210 includes a program storage area 211, a cache area 212, a remote copy area 213, a saving plan storage area 214, an unsorting process area 215, and a recovery process area 216. For example, the storage unit 210 is implemented as a storage space set aside in the RAM provided in the controller module 200a.

The program storage area 211 stores therein programs that are executed by the CPU provided in the controller module 200a. The cache area 212 stores therein data to be subjected to information processing performed by the CPU provided in the controller module 200a. The remote copy area 213 stores therein data that is received from the storage system 100 by remote copy. The saving plan storage area 214 stores therein a saving plan. The unsorting process area 215 is used for canceling sorting, as will be described later. The recovery process area 216 is used by a recovery processing unit 222.

The control unit 220 includes a save copy processing unit 221 and the recovery processing unit 222. For example, at least part of processes performed by the control unit 220 is implemented by causing the CPU provided in the controller module 200a to execute intended programs.

The save copy processing unit 221 receives a saving plan from the controller module 100a. Also, the save copy processing unit 221 receives save data from the controller module 100a.

The recovery processing unit 222 combines save data received from the controller module 100a and save data stored in the disaster-proof device 300. If the combined save data has been sorted by the controller module 100a, the recovery processing unit 222 unsorts the save data. The recovery processing unit 222 performs the recovery process on the combined save data. Thereby, the controller module 200a is able to recover the save data saved in the controller module 200a and the save data saved in the disaster-proof device 300.

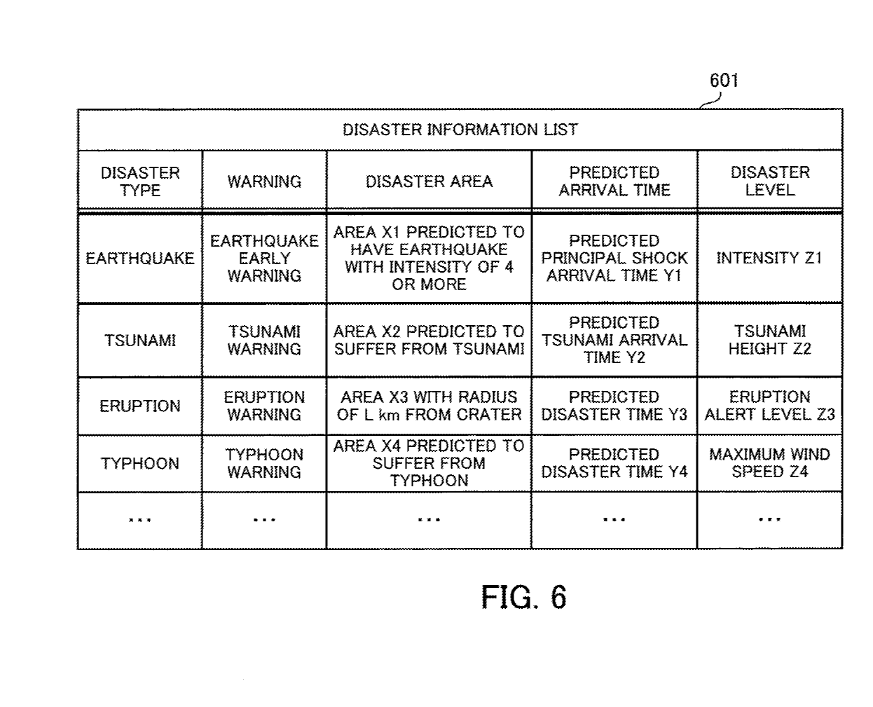

FIG. 6 illustrates a disaster information list according to the second embodiment. The disaster information list 601 lists examples of disaster information that is disseminated by the disaster information dissemination apparatus 600. The disaster information list 601 includes fields for the following items: Disaster Type, Warning, Disaster Area, Predicted Arrival Time, and Disaster Level.

The Disaster Type field contains the name of a disaster. For example, disaster types include earthquake, tsunami, eruption, typhoon, heavy rain, fire, missile, terrorist attack, and others. The Warning field contains the name of a warning message. The Disaster Area field indicates an area that is predicted to suffer from the disaster. The Predicted Arrival Time field indicates a time when the area is predicted to suffer from the disaster. The Disaster Level field indicates a level of the disaster.

For example, the disaster information receiving unit 121 receives disaster information with “earthquake” as a disaster type, “earthquake early warning” as a warning, “area X1 predicted to have earthquake with intensity of 4 or more” as a disaster area, “predicted principal shock arrival time Y1” as a predicted arrival time, and “intensity Z1” as a disaster level.

In this connection, the disaster information may include items other than those indicated in the disaster information list 601. For example, in the case where the disaster type is typhoon, the disaster information may include information such as the moving speed or predicted path of the typhoon. In addition, the disaster information may include information indicating a time remaining until the disaster area suffers from the disaster. For example, a time period of 25 seconds is set as the time remaining until the disaster area suffers from the disaster.

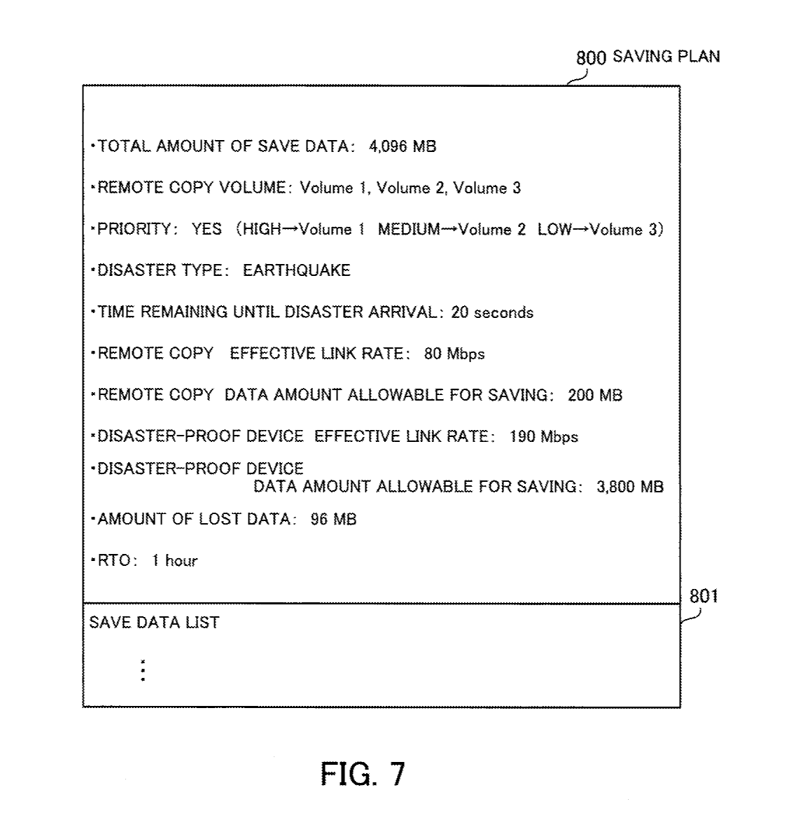

FIG. 7 illustrates an example of a saving plan according to the second embodiment. The saving plan 800 includes information indicating a total amount of save data, a remote copy volume, a priority, a disaster type, a time remaining until disaster arrival, a Recovery Time Objective (RTO), a save data list 801, and others. The saving plan 800 is created by the saving plan creation unit 123 on the basis of the transfer rate information 119, priority information, and others.

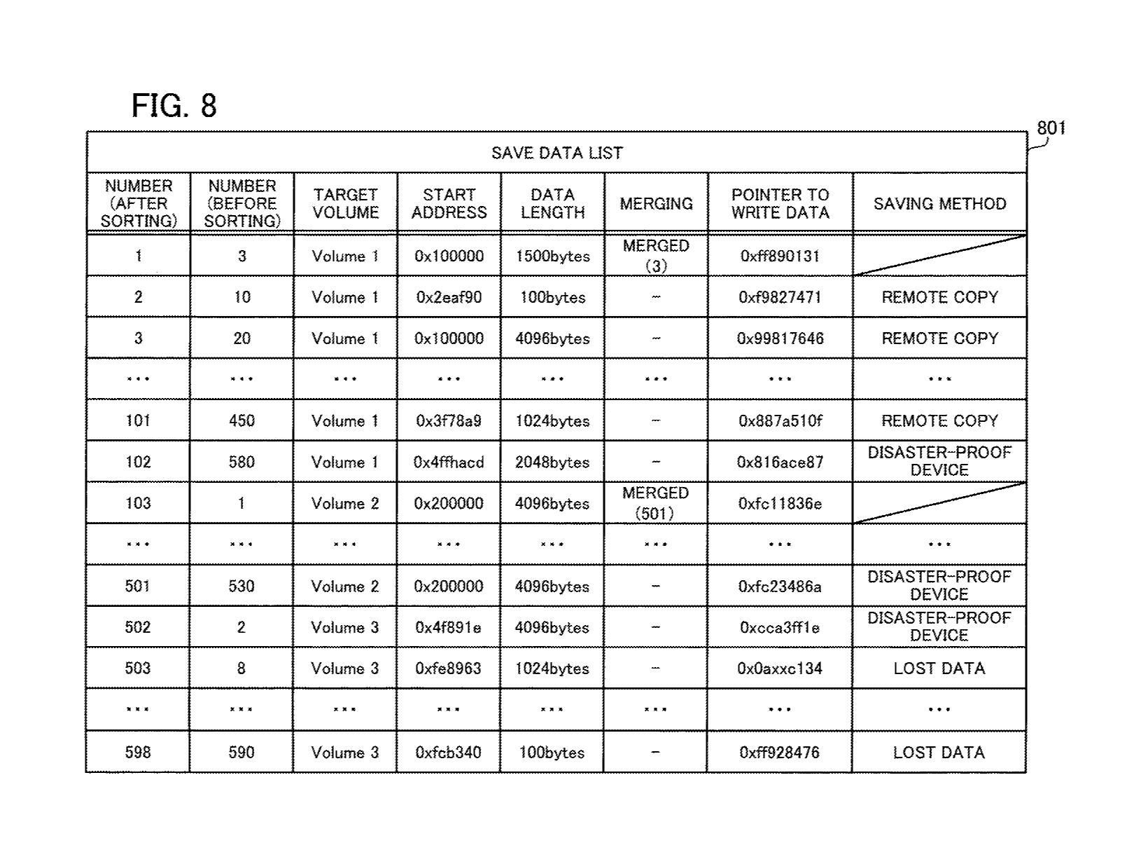

FIG. 8 illustrates an example of a save data list according to the second embodiment. The save data list 801 includes fields for the following items: Number (After Sorting), Number (Before Sorting), Target Volume, Start Address, Data Length, Merging, Pointer to Write Data, and Saving Method.

The Number (After Sorting) field indicates a state after a sorting process. The Number (Before Sorting) field indicates a state before the sorting process. The Target Volume field contains the name of a logical volume storing save data. The Start Address field indicates the start Logical Block Addressing (LBA) of the save data in the logical volume. The Data Length field indicates the data length of the save data. The Merging field indicates whether the save data has been merged or not. For example, a record with “1” in the Number (After Sorting) field and “Merged (3)” in the Merging field in the save data list 801 means that the save data identified by the number “1” after sorting has been merged into the save data indicated by the number “3” after sorting.

The Pointer to Write Data field indicates a pointer to the save data stored in the remote copy area 113. The Saving Method field indicates “remote copy”, “disaster-proof device”, or “lost data”, for example. The “remote copy” means that the save data is saved in the storage system 200 by a remote copy. The “disaster-proof device” means that the save data is saved in the disaster-proof device 300. The “lost data” means that the save data is not saved in either the storage system 200 or the disaster-proof device 300. In this connection, with respect to save data merged, the saving plan creation unit 123 does not register any of “remote copy”, “disaster-proof device”, and “lost data” in the Saving Method field.

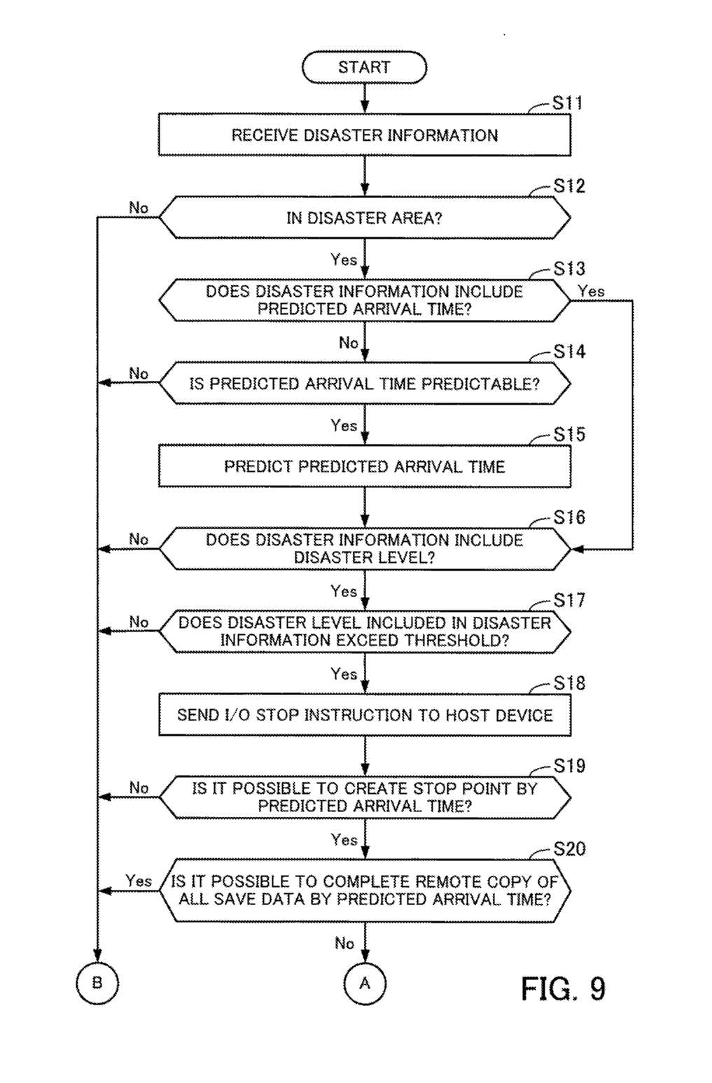

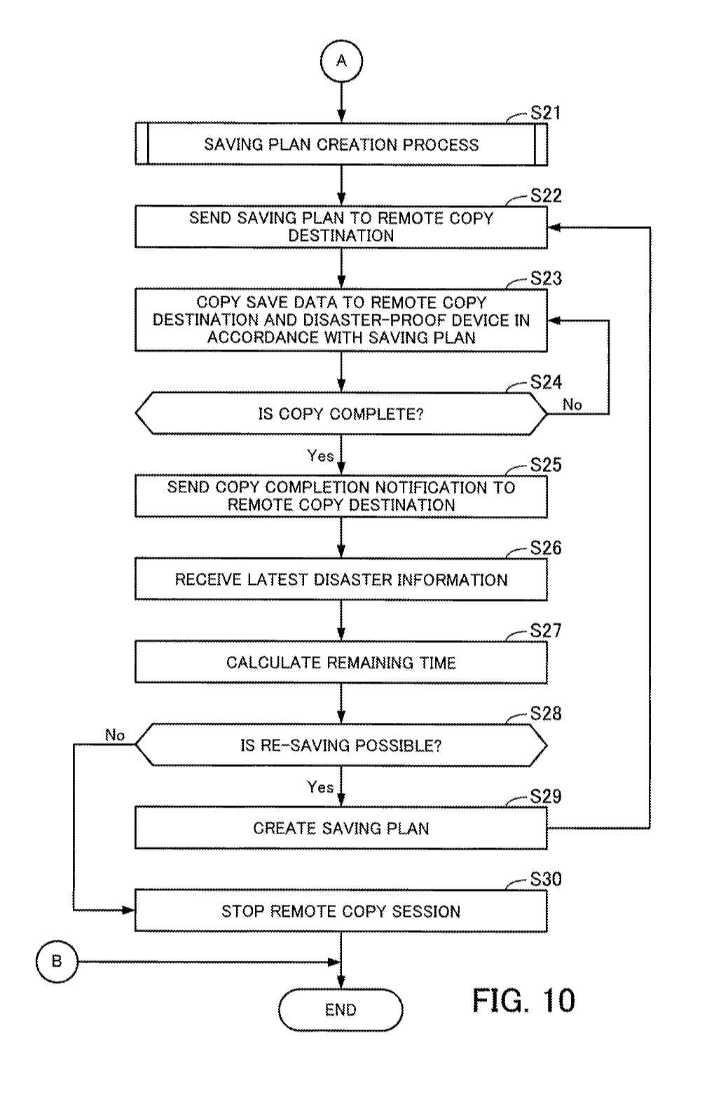

The following describes processes that are performed by the controller module 100a, with reference to flowcharts. FIGS. 9 and 10 illustrate an example of a flowchart for a data saving process according to the second embodiment. The controller module 100a performs the data saving process upon receipt of disaster information.

(S11) The disaster information receiving unit 121 receives disaster information disseminated by the disaster information dissemination apparatus 600 via the management terminal 500. In this connection, an administrator may enter such disaster information to the management terminal 500, and the disaster information receiving unit 121 may receive the disaster information from the management terminal 500. Alternatively, the disaster information receiving unit 121 may receive the disaster information from the disaster information dissemination apparatus 600 via a dedicated line, not via the management terminal 500.

(S12) The save determination unit 122 detects the location of the storage system 100 from the location information 117. The save determination unit 122 then determines based on the disaster area indicated in the disaster information whether the location of the storage system 100 is included in the disaster area. If the location is included in the disaster area, the save determination unit 122 proceeds to step S13. If the location is not included in the disaster area, the save determination unit 122 completes the data saving process.

(S13) The save determination unit 122 determines whether the disaster information includes a predicted arrival time. If the disaster information includes the predicted arrival time, the save determination unit 122 proceeds to step S16. If the disaster information does not include the predicted arrival time, the save determination unit 122 proceeds to step S14.

(S14) The save determination unit 122 determines whether the predicted arrival time is predictable. For example, the save determination unit 122 is able to predict a predicted arrival time of a disaster on the basis of an eruption warning, typhoon warning, or the like. If the predicted arrival time is predictable, the save determination unit 122 proceeds to step S15. If the predicated arrival time is unpredictable, the save determination unit 122 completes the data saving process.

(S15) The save determination unit 122 predicts the predicted arrival time. For example, the save determination unit 122 is able to calculate the predicted arrival time using prescribed parameters.

(S16) The save determination unit 122 determines whether the disaster information includes a disaster level. If the disaster information includes the disaster level, the save determination unit 122 proceeds to step S17. If the disaster information does not include the disaster level, the save determination unit 122 completes the data saving process.

(S17) The save determination unit 122 determines based on the disaster level information 118 whether the disaster level included in the disaster information exceeds the threshold indicated in the disaster level information 118. For example, in the case where the disaster level indicated in the disaster information is “intensity of 5” and the threshold indicated in the disaster level information 118 is “intensity of 4”, the save determination unit 122 determines that the disaster level indicated in the disaster information exceeds the threshold indicated in the disaster level information 118. If the threshold is exceeded, the save determination unit 122 determines that the storage system 100 will suffer from the disaster, and then proceeds to step S18. If the threshold is not exceeded, the save determination unit 122 completes the data saving process.

(S18) The save determination unit 122 sends, to the host device 400, an input-output (I/O) stop instruction to stop inputs and outputs of the host device 400.

(S19) The save determination unit 122 determines whether it is possible to create a stop point by the predicted arrival time. The stop point is information indicating a time point when the inputs and outputs are stopped. If it is possible to create the stop point, the save determination unit 122 creates the stop point. The save determination unit 122 takes, as data to be saved, data that is stored in the remote copy area 113 until the stop point and is to be remotely copied, and determines the data to be saved, as save data. Hereinafter, the amount of save data determined is referred to as the total amount of save data. Then, the save determination unit 122 proceeds to step S20. If it is not possible to create the stop point, the save determination unit 122 completes the data saving process.

(S20) The save determination unit 122 determines whether it is possible to complete the remote copy of all the save data by the predicted arrival time. For example, the save determination unit 122 obtains the effective link rate for the remote copy from the transfer rate information 119. The save determination unit 122 calculates the disaster arrival remaining time from the current time to the predicted arrival time. The save determination unit 122 calculates the amount of data that is able to be remotely copied (referred to as remote-copyable data amount), using the equation (1):

Remote-Copyable Data Amount=Effective Link Rate×Disaster Arrival Remaining Time×Safety Coefficient (1),

where the safety coefficient is 0.8, for example.

The save determination unit 122 compares the remote-copyable data amount with the total amount of save data. If the remote-copyable data amount is greater than the total amount of save data, the save determination unit 122 remotely copies the save data stored in the remote copy area 113, to the storage system 200, and then completes the data saving process. If the remote-copyable data amount is smaller than the total amount of save data, the process proceeds to step S21.

(S21) The saving plan creation unit 123 performs a saving plan creation process to create a saving plan 800. In addition, the saving plan creation unit 123 registers information about the save data stored in the remote copy area 113, in the save data list 801. Thereby, the saving plan creation unit 123 associates the save data stored in the remote copy area 113 with the information contained in the save data list 801.

(S22) The save copy processing unit 124 copies the saving plan 800 stored in the saving plan storage area 115 to the storage system 200. In this connection, the save copy processing unit 124 may copy the saving plan 800 to the disaster-proof device 300.

In this connection, at step S22 of the second and successive iterations, the save copy processing unit 124 copies, to the storage system 200, a saving plan in which the Saving Method field of the save data list 801 has been changed from “lost data” to “remote copy” or “disaster-proof device”.

(S23) The save copy processing unit 124 remotely copies save data corresponding to “remote copy” registered in the Saving Method field of the save data list 801, to the storage system 200 in accordance with the saving plan 800. In addition, the save copy processing unit 124 copies save data corresponding to “disaster-proof device” registered in the Saving Method field of the save data list 801, to the disaster-proof device 300 in accordance with the saving plan 800.

In this connection, at step S23 of the second and successive iterations, the save copy processing unit 124 copies only save data with respect to which the Saving Method field of the save data list 801 has been changed from “lost data” to “disaster-proof device” or “remote copy”, to the disaster-proof device 300 or storage system 200.

(S24) The save copy processing unit 124 determines whether the copy to the storage system 200 and disaster-proof device 300 is complete or not. If the copy is complete, the save copy processing unit 124 proceeds to step S25. If the copy has not been completed, the save copy processing unit 124 proceeds back to step S23.

(S25) The save copy processing unit 124 sends a copy completion notification to the storage system 200.

(S26) The disaster information receiving unit 121 receives the latest disaster information. The latest disaster information is received in one of the ways described in step S11.

(S27) The save determination unit 122 calculates a time remaining until the disaster. The save determination unit 122 executes step S27 when the storage system 100 does not suffer from the disaster at the time of this step S27. In this connection, the remaining time is a time from the current time to the predicted arrival time indicated in the latest disaster information. In addition, if the latest disaster information does not include the predicted arrival time, the save determination unit 122 performs the same process as steps S14 and S15 to calculate the predicted arrival time.

(S28) The save determination unit 122 determines whether the remaining time is sufficient to re-save at least part of save data corresponding to “lost data” registered in the Saving Method field of the save data list 801. The save determination unit 122 sets five seconds as a time needed to re-save at least part of the save data. If the remaining time is more than the time needed for the re-saving, the save determination unit 122 proceeds to step S29. If the remaining time is less than the time for the re-saving, the save determination unit 122 proceeds to step S30.

(S29) The saving plan creation unit 123 refers to the saving plan 800 and creates a saving plan 800 by changing “lost data” to “disaster-proof device” in the Saving Method field of the save data list 801 with respect to save data that is copyable to the disaster-proof device 300 within the remaining time. For example, the saving plan creation unit 123 calculates the data amount by multiplying the effective copy rate for copying to the disaster-proof device 300, the remaining time, and the safety coefficient. The saving plan creation unit 123 changes “lost data” to “disaster-proof device” for the calculated data amount. Then, the saving plan creation unit 123 proceeds to step S22.

In addition, the saving plan creation unit 123 may change “lost data” to “remote copy” in the Saving Method field of the save data list 801 with respect to save data that is copyable to the storage system 200 within the remaining time. In this case, the saving plan creation unit 123 calculates the data amount by multiplying the effective link rate for executing remote copy to the storage system 200, the remaining time, and the safety coefficient. The saving plan creation unit 123 changes “lost data” to “remote copy” for the calculated data amount.

Further, the saving plan creation unit 123 may change “lost data” to “remote copy” and “disaster-proof device” in the Saving Method field of the save data list 801 with respect to save data that is copyable to the storage system 200 and disaster-proof device 300 within the remaining time.

(S30) The save copy processing unit 124 stops the remote copy session, and then completes the data saving process.

If some time still remains until the disaster, the storage system 100 copies lost data to the disaster-proof device 300 or storage system 200. Thereby, the storage system 100 is able to reduce the amount of lost data.

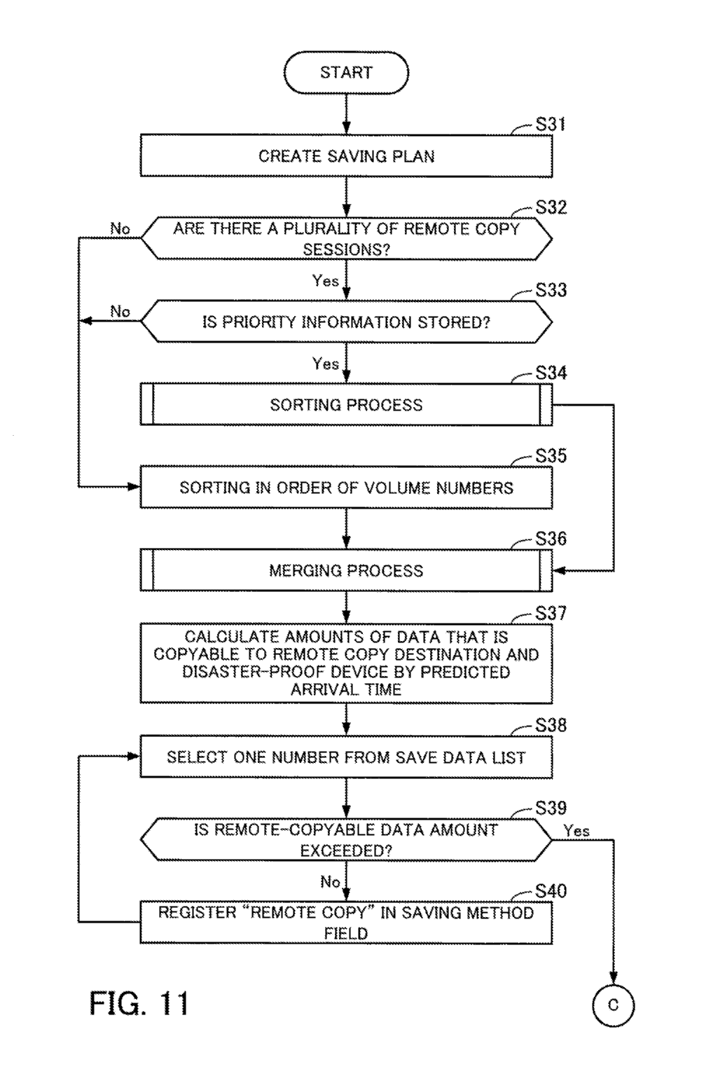

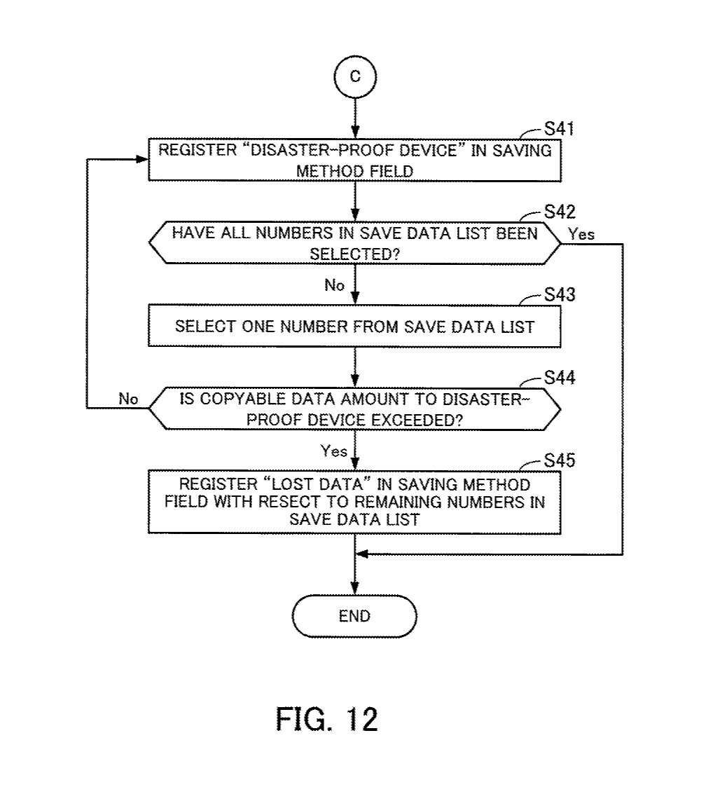

FIGS. 11 and 12 illustrate an example of a flowchart for a saving plan creation process according to the second embodiment. The controller module 100a performs the saving plan creation process at the time of step S21.

(S31) The saving plan creation unit 123 creates a saving plan 800 on the basis of the transfer rate information 119 and others. For example, the saving plan creation unit 123 creates the saving plan 800 including the total amount of save data, the disaster type, the effective link rate for remote copy, and others. In addition, the saving plan creation unit 123 registers information regarding the save data stored in the remote copy area 113, in the save data list 801. In this connection, the saving plan creation unit 123 sets NULL in the Number (After Sorting), Merging, and Saving Method fields in the save data list 801. The saving plan creation unit 123 stores the saving plan 800 in the saving plan storage area 115.

(S32) The saving plan creation unit 123 determines whether there are a plurality of remote copy sessions. If a plurality of remote copy sessions are found, the saving plan creation unit 123 proceeds to step S33. If a plurality of remote copy sessions are not found, the saving plan creation unit 123 proceeds to step S35.

(S33) The saving plan creation unit 123 determines whether priority information is stored in the storage unit 110. If the priority information is stored, the saving plan creation unit 123 proceeds to step S34. If no priority information is stored, the saving plan creation unit 123 proceeds to step S35.

(S34) The saving plan creation unit 123 performs a sorting process to sort the save data in order of priority. The saving plan creation unit 123 registers the state after the sorting, in the Number (After Sorting) field of the save data list 801. The saving plan creation unit 123 then proceeds to step S36.

(S35) The saving plan creation unit 123 sorts the save data in order of volume number indicated in the Target Volume field of the save data list 801. The saving plan creation unit 123 then registers the state after the sorting, in the Number (After Sorting) field of the save data list 801.

(S36) The saving plan creation unit 123 performs a merging process. In this merging process, the saving plan creation unit 123 detects overlapping save data.

(S37) The save determination unit 122 calculates a disaster arrival remaining time from the current time to the predicted arrival time. The save determination unit 122 obtains the effective link rate for remote copy, from the transfer rate information 119. The save determination unit 122 calculates the remote-copyable data amount for the remote copy to the storage system 200, using the equation (1).

In addition, the save determination unit 122 obtains the effective copy rate for copy to the disaster-proof device 300, from the transfer rate information 119. The save determination unit 122 calculates the amount (referred to as copyable data amount) of data that is copyable to the disaster-proof device 300, using the equation (2):

Copyable Data Amount=Effective Copy Rate×Disaster Arrival Remaining Time×Safety Coefficient (2),

where the safety coefficient is 0.8, for example.

(S38) The saving plan creation unit 123 selects one number in the Number (After Sorting) field of the save data list 801, in order starting from the beginning. In addition, when the selected number indicates “merged” in the save data list 801, the saving plan creation unit 123 skips the selected number and then selects the next number.

(S39) The saving plan creation unit 123 calculates the data amount by adding the data amount that is a sum of all data lengths of save data corresponding to “remote copy” registered in the Saving Method field of the save data list 801, and the data length corresponding to the number selected at step S38. The saving plan creation unit 123 determines whether the calculated data amount exceeds the remote-copyable data amount calculated using the equation (1) at step S37. If the calculated data amount exceeds the remote-copyable data amount, the saving plan creation unit 123 proceeds to step S41. If the calculated data amount does not exceed the remote-copyable data amount, the saving plan creation unit 123 proceeds to step S40.

In this connection, if there is no record with “remote copy” in the Saving Method field of the save data list 801, the saving plan creation unit 123 proceeds to step S40.

(S40) The saving plan creation unit 123 registers “remote copy” in the Saving Method field of the save data list 801 with respect to the number selected at step S38. The saving plan creation unit 123 then proceeds to step S38.

(S41) The saving plan creation unit 123 registers “disaster-proof device” in the Saving Method field of the save data list 801.

(S42) The saving plan creation unit 123 determines whether all numbers in the save data list 801 have been selected. If all the numbers have been selected, the saving plan creation unit 123 registers the data amount of save data to be remotely copied to the storage system 200, and the data amount of save data to be copied to the disaster-proof device 300, in the saving plan 800. The saving plan creation unit 123 then completes the saving plan creation process. If all the numbers have not been selected, the saving plan creation unit 123 proceeds to step S43.

(S43) The saving plan creation unit 123 selects one number from the Number (After Sorting) field of the save data list 801, in order from the number following the number selected at step S38. The saving plan creation unit 123 skips the number if the save data with the number has been merged, among the numbers of the save data list 801.

(S44) The saving plan creation unit 123 calculates the data amount by adding the data amount that is the sum of all data lengths of save data corresponding to “disaster-proof device” registered in the Saving Method field of the save data list 801, and the data length corresponding to the number selected at step S43. The saving plan creation unit 123 then determines whether the calculated data amount exceeds the copyable data amount calculated using the equation (2) at step S37. If the data amount exceeds the copyable data amount, the saving plan creation unit 123 proceeds to step S45. If the data amount does not exceed the copyable data amount, the saving plan creation unit 123 proceeds to step S41.

In this connection, if there is no record with “disaster-proof device” in the Saving Method field of the save data list 801, the saving plan creation unit 123 proceeds to step S41.

(S45) The saving plan creation unit 123 registers “lost data” in the Saving Method field of the save data list 801 with respect to the number selected at step S43. In addition, the saving plan creation unit 123 registers “lost data” in the Saving Method field with respect to the remaining numbers of the save data list 801. The saving plan creation unit 123 registers, in the saving plan 800, the data amount of save data to be remotely copied to the storage system 200 for saving, the data amount of save data to be copied to the disaster-proof device 300, and the data amount of lost data. The saving plan creation unit 123 then completes the saving plan creation process.

The saving plan 800 created by the saving plan creation unit 123 as described above indicates that the save data is copied to the storage system 200 and disaster-proof device 300 in descending order of priority.

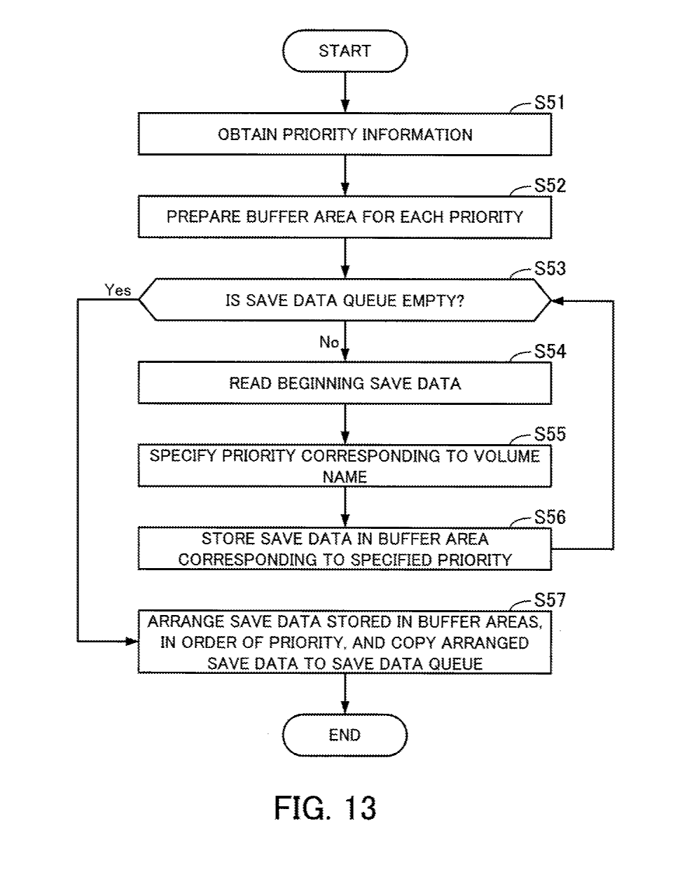

FIG. 13 illustrates an example of a flowchart for a sorting process according to the second embodiment. The controller module 100a performs the sorting process at the time of step S34.

(S51) The saving plan creation unit 123 obtains priority information from the storage unit 110. For example, the priority information indicates that the priority of Volume 1 is the highest (high priority), the priority of Volume 2 is the second highest (medium priority), and the priority of Volume 3 is the lowest (low priority). The saving plan creation unit 123 registers the priority information in the saving plan 800.

(S52) The saving plan creation unit 123 obtains the save data from the remote copy area 113, and stores the save data in a queue structure in the sorting and merging process area 116. In this connection, the queue structure of the save data is hereinafter referred to as a save data queue. The saving plan creation unit 123 prepares buffer areas for “high” priority, “medium” priority, and “low” priority in the sorting and merging process area 116. The prepared buffer areas have the queue structure.

(S53) The saving plan creation unit 123 determines whether the save data queue is empty or not. If the save data queue is empty, the saving plan creation unit 123 proceeds to step S57. If the save data queue is not empty, the saving plan creation unit 123 proceeds to step S54.

(S54) The saving plan creation unit 123 reads the beginning save data from the save data queue. In this connection, the save data is stored in the save data queue in order of number indicated in the Number (Before Sorting) field of the save data list 801. Therefore, the beginning save data of the save data queue in the initial state is save data with “1” in the Number (Before Sorting) field of the save data list 801.

(S55) The saving plan creation unit 123 refers to the save data list 801 and priority information to specify the priority corresponding to the volume name for the read save data.

(S56) The saving plan creation unit 123 stores the save data read at step S54, in the buffer area corresponding to the specified priority. For example, in the case where the specified priority is “high”, the saving plan creation unit 123 stores the save data read at step S54, in the buffer area prepared for “high” priority. The process then proceeds to step S53.

(S57) The saving plan creation unit 123 reads the save data stored in the buffer areas for “high” priority, “medium” priority, and “low” priority, and arranges the save data in descending order of priority. That is, the saving plan creation unit 123 arranges the save data with “medium” priority following the save data with “high” priority. The saving plan creation unit 123 arranges the save data with “low” priority following the save data with “medium” priority. The saving plan creation unit 123 copies the save data arranged in this way, to the save data queue. The saving plan creation unit 123 registers the order of the arranged save data in the Number (After Sorting) field of the save data list 801.

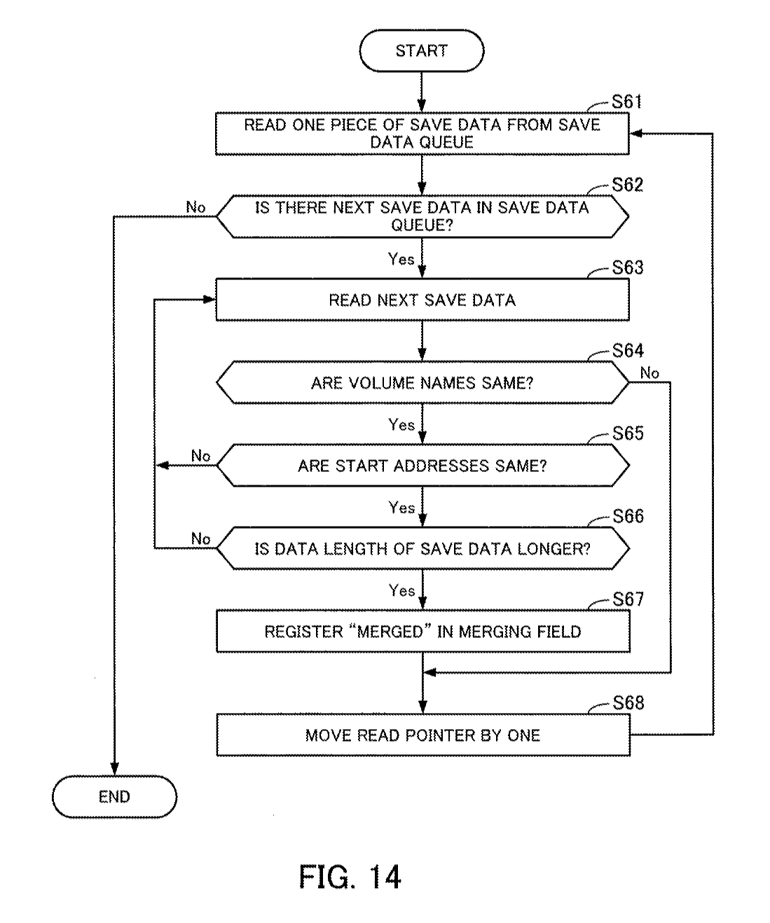

FIG. 14 illustrates an example of a flowchart for the merging process according to the second embodiment. The controller module 100a performs the merging process at the time of step S36.

(S61) The saving plan creation unit 123 reads one piece of the save data from the save data queue in order starting from the beginning.

(S62) The saving plan creation unit 123 determines whether there is save data next to the read save data in the save data queue. If the next save data is stored in the save data queue, the saving plan creation unit 123 proceeds to step S63. If no next save data is stored in the save data queue, the saving plan creation unit 123 stores the save data stored in the save data queue, in the remote copy area 113. The saving plan creation unit 123 then completes the merging process.

In addition, for example, the determination of step S62 is equivalent to a determination as to whether all data stored in the save data queue has been read by the saving plan creation unit 123.

(S63) The saving plan creation unit 123 reads the save data next to the save data read at step S61. In addition, in the case where step S63 is executed next to step S65 or S66, the saving plan creation unit 123 reads save data next to the save data read at step S63 executed last time.

(S64) The saving plan creation unit 123 determines with reference to the save data list 801 whether the volume name corresponding to the save data read at step S61 is the same as that corresponding to the save data read at step S63. If these volume names are the same, the process proceeds to step S65. If the volume names are different, the process proceeds to step S68.

(S65) The saving plan creation unit 123 determines with reference to the save data list 801 whether the start address of the save data read at step S61 is the same as that of the save data read at step S63. If these start addresses are the same, the saving plan creation unit 123 proceeds to step S66. If the start addresses are different, the saving plan creation unit 123 proceeds to step S63.

(S66) The saving plan creation unit 123 determines with reference to the save data list 801 whether the data length of the save data read at step S61 is longer than or equal to that of the save data read at step S63. If the data length of the save data read at step S61 is longer than or equal to that of the save data read at step S63, the saving plan creation unit 123 proceeds to step S67. If the data length of the save data read at step S61 is shorter, the saving plan creation unit 123 proceeds to step S63.

(S67) The saving plan creation unit 123 registers “Merged” in the Merging field of the save data list 801 with respect to the save data read at step S61. In addition, the saving plan creation unit 123 registers a merging destination in the Merging field of the save data list 801.

(S68) The saving plan creation unit 123 moves the read pointer by one. The saving plan creation unit 123 then proceeds to step S61.

The storage system 100 merges overlapping save data. By doing so, the storage system 100 is able to reduce the total amount of save data. The reduction in the total amount of save data increases the amount of data that is able to be saved in the storage system 200 and the disaster-proof device 300, and thus reduces the data amount of lost data.

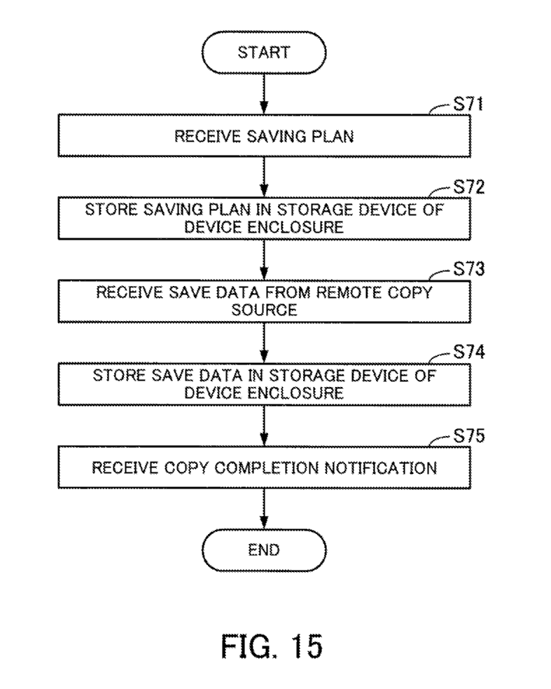

The following describes processes that are performed when the controller module 200a receives the saving plan 800 and save data, with reference to flowcharts. FIG. 15 illustrates an example of a flowchart for a storing process according to the second embodiment. The controller module 200a performs the storing process upon receipt of the saving plan 800.

(S71) The save copy processing unit 221 receives the saving plan 800 from the controller module 100a, and then stores the saving plan 800 in the saving plan storage area 214.

(S72) The save copy processing unit 221 stores the saving plan 800 in a storage device of the device enclosure 200b.

(S73) The save copy processing unit 221 receives the save data from the controller module 100a, and stores the save data in the remote copy area 213.

(S74) The save copy processing unit 221 stores the save data in the storage device of the device enclosure 200b.

(S75) The save copy processing unit 221 receives a copy completion notification from the controller module 100a, and then completes the storing process.

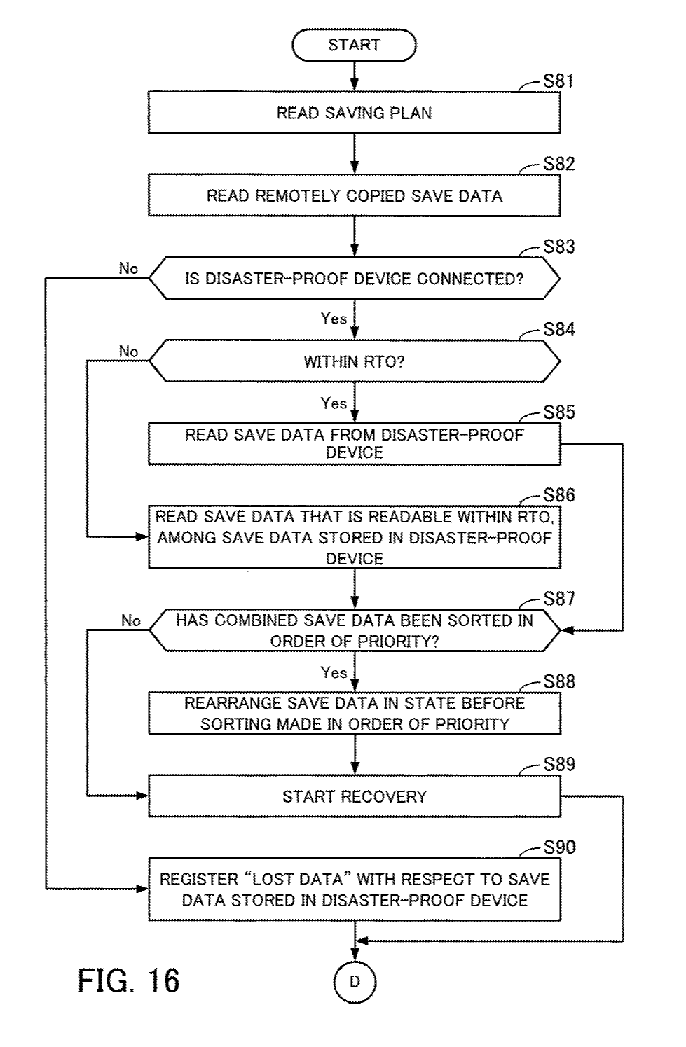

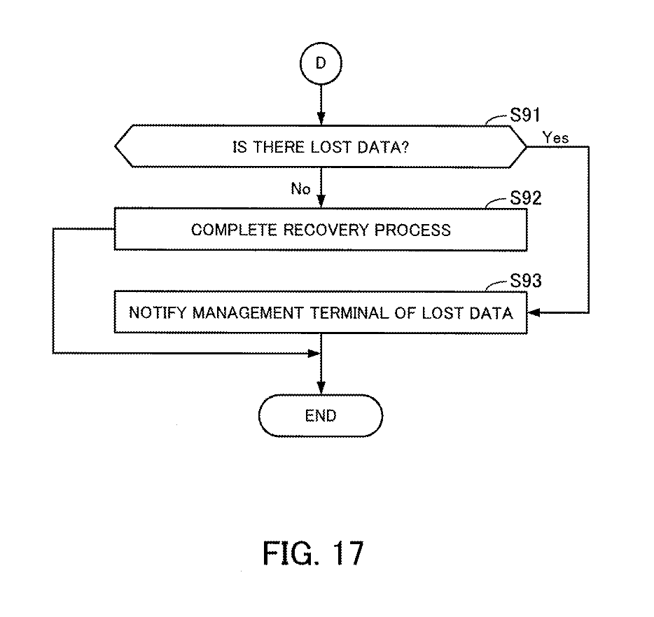

The following describes a recovery process with reference to a flowchart. FIGS. 16 and 17 illustrate an example of a flowchart for the recovery process according to the second embodiment. The controller module 200a performs the recovery process upon receipt of a recovery instruction from the management terminal 700.

(S81) The recovery processing unit 222 reads the saving plan 800 from the storage device of the device enclosure 200b, and stores the read saving plan 800 in the saving plan storage area 214.

(S82) The recovery processing unit 222 reads the save data from the storage device of the device enclosure 200b, and stores the read save data in the recovery process area 216.

(S83) The recovery processing unit 222 determines whether the disaster-proof device 300 is connected to the storage system 200. For example, the administrator brings the disaster-proof device 300, which has been connected to the storage system 100, to the storage system 200, and then connects the disaster-proof device 300 to the storage system 200. Alternatively, the disaster-proof device 300 and the storage system 200 may be connected over a network. In this case, the recovery processing unit 222 determines whether the disaster-proof device 300 is connected to (or is able to communicate with) the storage system 200 over the network.

If the disaster-proof device 300 is connected, the recovery processing unit 222 proceeds to step S84. If the disaster-proof device 300 is not connected, the recovery processing unit 222 proceeds to step S90.

(S84) The recovery processing unit 222 obtains RTO with reference to the saving plan 800. If the administrator brings the disaster-proof device 300, the recovery processing unit 222 predicts the time to transport the disaster-proof device 300 from the storage system 100 to the storage system 200. If this transportation time is predicted in advance, the recovery processing unit 222 does not predict it at this time. The recovery processing unit 222 determines whether the sum of the time to read the save data from the disaster-proof device 300 and the transportation time is within the RTO. In this connection, the time to read the save data from the disaster-proof device 300 may be calculated, in advance, on the basis of the rate for reading data from the disaster-proof device 300. This data read rate is stored in the storage unit 210 in advance.

In the case where the disaster-proof device 300 is connected to the storage system 200 over the network, the recovery processing unit 222 determines whether the time to read the save data from the disaster-proof device 300 is within the RTO. In this connection, the time to read the save data from the disaster-proof device 300 may be calculated, in advance, on the basis of the rate for reading data from the disaster-proof device 300. This data read rate is stored in the storage unit 210 in advance.

If such a time is within the RTO, the recovery processing unit 222 proceeds to step S85. If the time exceeds the RTO, the recovery processing unit 222 proceeds to step S86.

(S85) The recovery processing unit 222 reads the save data from the disaster-proof device 300. Then, the recovery processing unit 222 proceeds to step S87.

(S86) The recovery processing unit 222 reads save data that is readable within the RTO, among the save data stored in the disaster-proof device 300. For example, the rate information about the rate for reading data from the disaster-proof device 300 is stored in the storage unit 210, and the recovery processing unit 222 calculates the amount of data that is readable within the RTO, on the basis of the rate information. The recovery processing unit 222 then reads the calculated amount of data from the disaster-proof device 300.

The recovery processing unit 222 refers to the save data list 801 and registers “lost data” in the Saving Method field with respect to the save data that is not readable within the RTO.

(S87) The recovery processing unit 222 combines the save data read at step S85 or step S86 and the save data stored in the recovery process area 216. The recovery processing unit 222 determines whether the combined save data has been sorted in order of priority. That is, the recovery processing unit 222 determines whether the save data has been sorted in order of number indicated in the Number (After Sorting) field of the save data list 801. If the save data has been sorted in order of priority, the recovery processing unit 222 proceeds to step S88. If the save data has not been sorted in order of priority, the recovery processing unit 222 proceeds to step S89.

(S88) The recovery processing unit 222 stores the combined save data in the unsorting process area 215. The recovery processing unit 222 rearranges the combined save data in a state before the sorting made in order of priority. That is, the recovery processing unit 222 rearranges the combined save data in order of number indicated in the Number (Before Sorting) field of the save data list 801.

(S89) The recovery processing unit 222 starts the recovery on the basis of the save data list 801. For example, the recovery processing unit 222 stores the save data corresponding to the target volume “Volume 1”, in the volume “Volume 1” of the storage system 200. The recovery processing unit 222 then proceeds to step S91.

(S90) The recovery processing unit 222 changes the Saving Method field of the save data list 801 from “disaster-proof device” to “lost data” with respect to the save data stored in the disaster-proof device 300. The recovery processing unit 222 then proceeds to step S91.

(S91) The recovery processing unit 222 determines with reference to the save data list 801 whether there is lost data. If the lost data is found, the recovery processing unit 222 proceeds to step S93. If no lost data is found, the recovery processing unit 222 proceeds to step S92.

(S92) The recovery processing unit 222 completes the recovery process.

(S93) The recovery processing unit 222 creates a list of lost data, and sends the list to the management terminal 700. The recovery processing unit 222 then completes the recovery process.

According to the second embodiment, the controller module 100a saves the save data in the storage system 200 and the disaster-proof device 300. This technique enables the controller module 100a to reduce the risk of losing the save data.

In addition, according to the second embodiment, the controller module 100a saves the save data in the storage system 200 and disaster-proof device 300 in a distributed manner. Therefore, the controller module 100a does not need to save all the save data in the disaster-proof device 300. Thereby, the information processing system of the second embodiment is able to reduce the cost for bandwidth reservation for a communication link between the controller module 100a and the storage system 200.

In addition, since the controller module 100a saves the save data in the storage system 200 and the disaster-proof device 300 in a distributed manner, it is possible to reduce the storage capacity needed for the disaster-proof device 300. Since the information processing system of the second embodiment does not need a disaster-proof storage unit for storing all save data, it is possible to reduce the cost for the disaster-proof storage unit.

Therefore, the second embodiment is able to reduce the risk of losing data at a low cost.

The storage system 100 creates the saving plan 800. The saving plan 800 indicates save data copied to the storage system 200 and save data copied to the disaster-proof device 300. In addition, the saving plan 800 indicates lost data that has not been copied to either the storage system 200 or the disaster-proof device 300. When performing the recovery process, the storage system 200 is able to specify, with reference to the saving plan 800, which save data is stored in the storage system 200 or disaster-proof device 300 and which save data is lost data.

Further, the information processing of the first embodiment is implemented by causing the processor provided in the information processing apparatus 2 to execute an intended program. The information processing of the second embodiment is implemented by causing the CPU 101 and the CPU provided in the controller module 200a to execute intended programs. Such a program may be recorded in a computer-readable recording medium.

For example, recording media on which the program is stored may be put on sale to distribute the program. In addition, programs for implementing the functions corresponding to the disaster information receiving unit 121, save determination unit 122, saving plan creation unit 123, save copy processing unit 124, save copy processing unit 221 and recovery processing unit 222 may individually be distributed as separate programs. The functions of the disaster information receiving unit 121, save determination unit 122, saving plan creation unit 123, save copy processing unit 124, save copy processing unit 221, and recovery processing unit 222 may be implemented by separate computers. The computer may store (install) a program recorded in a recording medium in the RAM 102, flash memory 103, or a RAM or flash memory provided in the controller module 200a, and read and execute the program.

According to one aspect, it is possible to reduce the risk of losing data at a low cost.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a memory configured to store therein data transfer rate information about a data transfer rate to a first storage apparatus located at a remote site and a data transfer rate to a second storage apparatus that is disaster-proof, and save data to be saved when a disaster occurs; and
a processor configured to perform a process including
obtaining disaster prediction information about a disaster prediction,
creating a saving plan for saving the save data by copying to the first storage apparatus and copying to the second storage apparatus, based on a predicted disaster time detected from the disaster prediction information and the data transfer rate information, and
saving the save data in the first storage apparatus and the second storage apparatus in accordance with the saving plan.

2. The information processing apparatus according to claim 1, wherein the creating of the saving plan includes creating the saving plan for saving the save data by performing an asynchronous remote copy to the first storage apparatus and performing a synchronous copy to the second storage apparatus, based on the predicted disaster time and the data transfer rate information.

3. The information processing apparatus according to claim 2, wherein the process further includes taking, as the save data, data that is copied when performing the asynchronous remote copy to the first storage apparatus.

4. The information processing apparatus according to claim 3, wherein the process further includes sending, when determining based on the disaster prediction information that the information processing apparatus will suffer from the disaster, an instruction for stopping access to a higher-level apparatus and taking, as the save data, data that is set to be copied before the instruction is made.

5. The information processing apparatus according to claim 1, wherein the creating of the saving plan includes creating, when the save data includes non-save data that is not able to be saved by the predicated disaster time, the saving plan including non-save information identifying the non-save data, and sending the saving plan to the first storage apparatus.

6. The information processing apparatus according to claim 5, wherein the process further includes creating, when the information processing apparatus does not suffer from the disaster after the save data is saved in the first storage apparatus and the second storage apparatus in accordance with the saving plan, a re-saving plan for saving at least part of the non-save data in the first storage apparatus and the second storage apparatus, and saving the at least part of the non-save data in the first storage apparatus and the second storage apparatus in accordance with the re-saving plan.

7. The information processing apparatus according to claim 5, wherein the process further includes determining the non-save data from among the save data, based on priority information indicating saving priority of the save data.

8. A non-transitory computer-readable recording medium storing a computer program that causes a computer to perform a process comprising:
obtaining disaster prediction information about a disaster prediction,
creating a saving plan for saving save data by copying to a first storage apparatus located at a remote site and copying to a second storage apparatus being disaster-proof, based on a predicted disaster time detected from the disaster prediction information and data transfer rate information about a data transfer rate to the first storage apparatus and a data transfer rate to the second storage apparatus, the save data being to be saved when a disaster occurs, and
saving the save data in the first storage apparatus and the second storage apparatus in accordance with the saving plan.

9. An information processing system comprising:
a first storage apparatus that is located at a remote site and is able to copy data;
a second storage apparatus that is disaster-proof and is able to copy data; and
an information processing apparatus that includes a memory and a processor, wherein:
the memory stores therein data transfer rate information about a data transfer rate to the first storage apparatus and a data transfer rate to the second storage apparatus, and save data to be saved when a disaster occurs; and
the processor performs a process including
obtaining disaster prediction information about a disaster prediction,
creating a saving plan for saving the save data by copying to the first storage apparatus and copying to the second storage apparatus, based on a predicted disaster time detected from the disaster prediction information and the data transfer rate information, and
saving the save data in the first storage apparatus and the second storage apparatus in accordance with the saving plan.

10. The information processing system according to claim 9, wherein:
the information processing apparatus sends the saving plan to the first storage apparatus; and
the first storage apparatus refers to the saving plan to perform a recovery process to recover the save data using data saved in the first storage apparatus and the second storage apparatus.
